(19) United States
(12) Patent Application Publication
(10) Pub. No.: US 2023/0063841 A1
(43) Pub. Date: Mar. 2, 2023

(54) CYLINDRICAL SECONDARY BATTERY CELL PRODUCTION APPARATUS AND METHOD

(71) Applicant: LG ENERGY SOLUTION, LTD., Seoul (KR)

(72) Inventors: Jun-Oh LEE, Daejeon (KR); Kyu-Hun SHIM, Daejeon (KR); Seung-Tae LEE, Daejeon (KR)

(73) Assignee: LG ENERGY SOLUTION, LTD., Seoul (KR)

(21) Appl. No.: 17/794,795

(22) PCT Filed: Jan. 14, 2022
(86) PCT No.: PCT/KR2022/000733

§ 371 Date: Jul. 22, 2022

(30) Foreign Application Priority Data
Jan. 14, 2021 (KR) 10-2021-0005503
Nov. 16, 2021 (KR) 10-2021-0158065

(51) Int. Cl. H01M 50/186; H01M 50/152; H01M 50/167; H01M 50/107; H01M 10/04

(52) U.S. Cl. CPC H01M 50/186; H01M 50/152; H01M 50/167; H01M 50/107; H01M 10/0422; H01M 10/0404

(57) ABSTRACT

An apparatus for producing a cylindrical secondary battery cell including a battery can in which an electrode assembly and an electrolytic solution are accommodated, a cap plate coupled to the battery can, and a gasket located between the battery can and the cap plate includes: a support member into which the cylindrical secondary battery cell is inserted in a state where an end portion of the battery can and an end portion of the gasket are arranged to face a preset direction and the cap plate contacts the gasket; at least one fixing member configured to fix the cylindrical secondary battery cell moved to a preset position by the support member; and a forming member located over the cylindrical secondary battery cell fixed by the fixing member and rotating and pressing the end portion of the battery can to form a crimping portion.

### TECHNICAL FIELD

The present application claims priority to Korean Patent Application Nos. 10-2021-0005503 and 10-2021-0158065 respectively filed on Jan. 14, 2021 and Nov. 16, 2021 in the Republic of Korea, the disclosures of which are incorporated herein by reference.

The present disclosure relates to a cylindrical secondary battery cell production apparatus and method, and more particularly, to a cylindrical secondary battery cell production apparatus and method in which a crimping portion is easily formed.

### BACKGROUND ART

As the development and demand for mobile devices has increased, the demand for secondary batteries as energy sources has rapidly increased. Nickel cadmium batteries or hydrogen ion batteries have been used as conventional secondary batteries, hut recently, lithium secondary batteries having little memory effect compared to nickel-based secondary batteries, free charging and discharging, a very low self-discharge rate, and high energy density have been widely used.

A lithium secondary battery mainly uses a lithium-based oxide and a carbon material as a positive electrode active material and a negative electrode active material, respectively. A lithium secondary battery includes an electrode assembly in which a positive electrode plate and a negative electrode plate to which a positive electrode active material and a negative electrode active material are respectively applied are located with a separator therebetween, and a casing in which the electrode assembly is sealed and accommodated along with an electrolytic solution, that is, a battery case.

A lithium secondary battery includes a positive electrode, a negative electrode, a separator located between the positive electrode and the negative electrode, and an electrolyte, and is divided into a lithium-ion battery (LIB), a polymer lithium-ion battery (PUB), and so on according to which of a positive electrode active material and a negative electrode active material is used. In general, an electrode of a lithium secondary battery is formed by applying a positive electrode or negative electrode active material to a current collector such as an aluminum or copper sheet, a mesh, a film, or a foil and then drying the same.

In general, secondary batteries may be classified into cylindrical, prismatic, or pouch-type secondary batteries according to a shape of a casing in which a secondary battery cell is accommodated, and cylindrical secondary batteries may be used as a secondary battery module by connecting a plurality of secondary battery cells in series or in parallel.

Referring to Korean Patent Application Publication No. 10-2018-0072990 that is a prior document, a primary crimping mold 240 moves downward to apply a primary pressure and a secondary crimping mold 250 applies a secondary pressure to an open upper end portion 211 of a metal can 210 in which an inclination is formed, to form a crimping portion 201.

However, as a size and a thickness of a cylindrical secondary battery cell increase, when a crimping portion is formed by a crimping mold of the prior art disclosed in the prior document, load applied to the crimping mold increases and a molding error also increases.

### DISCLOSURE

### Technical Problem

The present disclosure is designed to solve the problems of the related art, and therefore the present disclosure is directed to providing a cylindrical secondary battery cell production apparatus and method for forming a crimping portion accurately without an error even when a size and a thickness of a cylindrical secondary battery cell increase.

### Technical Solution

According to an aspect of the present disclosure, an apparatus for producing a cylindrical secondary battery cell including a battery can in which an electrode assembly and an electrolytic solution are accommodated, a cap plate coupled to the battery can, and a gasket located between the battery can and the cap plate includes: a support member configured to receive the cylindrical secondary battery cell therein in a state where an end portion of the battery can and an end portion of the gasket are arranged to face a preset direction and the cap plate contacts the gasket; at least one fixing member being movable relative to the support member to fix the cylindrical secondary battery cell after the cylindrical secondary batter cell is moved to a preset position by the support member; and a forming member located over the support member, the forming member being movable towards the cylindrical secondary battery cell fixed by the fixing member to press the end portion of the battery can and being rotatable to form a crimping portion of the cylindrical secondary battery cell.

The gasket may be located inside the battery can and contacts the battery can, and the cap plate is located inside the gasket and contacts the gasket, wherein the forming member is configured to press an outer side of the battery can.

The support member may include: a receiving portion into which the cylindrical secondary battery cell is insertable; and a first moving portion configured to move the cylindrical secondary battery cell toward the at least one fixing member.

An inner groove may be formed along a circumference of the battery can under the gasket, wherein the at least one fixing member is insertable into the inner groove to fix the cylindrical secondary battery cell.

The at least one fixing member may include: a fixing protrusion insertable into the inner groove; and a second moving portion coupled to the fixing protrusion to move the fixing protrusion.

The forming member may include: a support holder configured to contact the cap plate; a rotating plate rotatably coupled to the support to rotate about the support holder; and at least one forming roller coupled to the rotating plate, the at least one forming roller being configured to rotate with the rotating plate, and the at least one forming roller being configured to press the end portion of the battery can to form the crimping portion.

The at least one forming roller may be a pair of forming rollers coupled to the rotating plate at positions spaced apart from a center of the rotating plate to be rotatable around the support holder.

The at least one forming roller may include: a connection rod coupled to the rotating plate; and a pressing rod coupled to the connection rod, the pressing rod being spaced from the support holder, and the pressing rod being configured to press the end portion of the battery can.

The pressing rod may include: a rotating shaft coupled to the connection rod; and a roller member coupled to the rotating shaft.

An inclined portion may be formed on a portion of the roller member configured to contact the end portion of the battery can.

The forming member may be formed of a metal material.

According to another aspect of the present disclosure, a method of producing a cylindrical secondary battery cell including a battery can in which an electrode assembly and an electrolytic solution are accommodated, a cap plate coupled to an upper side of the battery can, and a gasket located between the battery can and the cap plate includes: inserting the cylindrical secondary battery cell into a support member in a state where an end portion of the battery can and an end portion of the gasket are arranged to face a preset direction and the cap plate contacts the gasket; moving the cylindrical secondary battery cell to a preset position by the support member, fixing, by a fixing member, the cylindrical secondary battery cell moved to the preset position by the support member; and forming a crimping portion by causing a forming member located over the support member to move towards the cylindrical secondary battery cell fixed by the fixing member and to rotate and press the end portion of the battery can with the forming member.

The forming member includes a rotating plate and a forming roller coupled to the rotating plate. The forming the crimping member includes rotating the rotating plate along with the forming roller to press the end portion of the battery can.

When an inner groove is formed along a circumference of the battery can under the gasket, the fixing the cylindrical secondary battery cell includes inserting the fixing member into the inner groove to fix the cylindrical secondary battery cell.

The forming member includes: a support holder; and the rotating plate rotatably coupled to the support holder to rotate about the support holder. The forming the crimping portion comprises moving the support holder to directly contact the cap plate such that the support holder does not rotate relative to the cap plate.

### Advantageous Effects

According to embodiments of the present disclosure, a crimping portion may be formed accurately without an error even when a size and a thickness of a cylindrical secondary battery cell increase.

### DESCRIPTION OF DRAWINGS

FIG. 1 is a view illustrating a cylindrical secondary battery cell of an embodiment before being formed by a cylindrical secondary battery cell production apparatus according to an embodiment of the present disclosure.

FIG. 2 is a view illustrating a cylindrical secondary battery cell of another embodiment before being formed by a cylindrical secondary battery cell production apparatus according to an embodiment of the present disclosure,

FIG. 3 is a view illustrating a state where a cylindrical secondary battery cell is inserted into a support member in a cylindrical secondary battery cell production apparatus according to an embodiment of the present disclosure.

FIG. 4 is a view illustrating a state where the support member of FIG. 3 is lifted and a forming member is partially lowered.

FIG. 5 is a view illustrating a state where a fixing member of FIG. 4 is used to fix cylindrical secondary battery cell.

FIG. 6 is a view illustrating a state where the forming member of FIG. 5 is completely lowered to rotate and press an end portion of a bottom can of a cylindrical secondary battery cell, to form a crimping portion.

FIG. 7 is a view illustrating a state where forming of the crimping portion of the cylindrical secondary battery cell of FIG. 6 is completed and then the forming member is partially lifted.

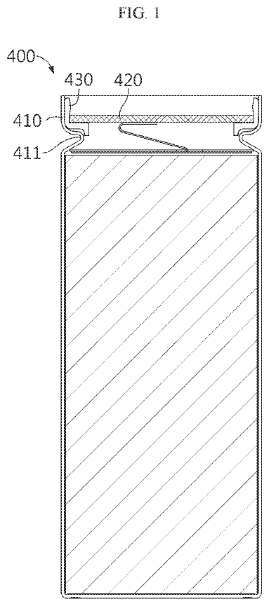

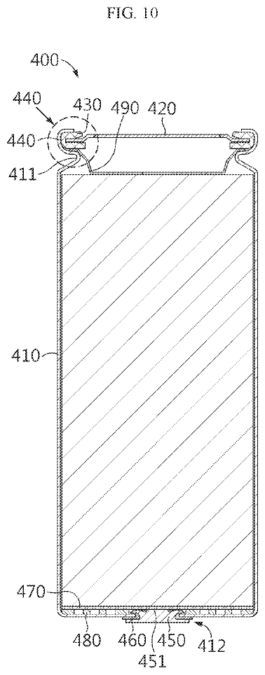

FIG. 1 is a view illustrating a state where the forming member of FIG. 7 is completely lifted, the fixing member is separated from the cylindrical secondary battery cell, and the support member is lowered.

FIG. 9 is a view illustrating a state where the cylindrical secondary battery cell of FIG. 1 is formed by a cylindrical secondary battery cell production apparatus according to an embodiment of the present disclosure.

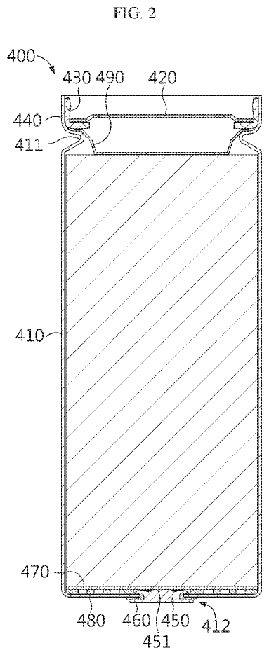

FIG. 10 is a view illustrating a state where the cylindrical secondary battery cell of FIG. 2 is formed by a cylindrical secondary battery cell production apparatus according to an embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

The size of each element or a specific portion of the element shown in the drawings may be exaggerated, omitted or schematically drawn for the purpose of convenience and clarity of explanation. Accordingly, the size of each element may not substantially reflect its actual size. While describing the present disclosure, detailed descriptions of related well-known functions or configurations that may blur the points of the present disclosure are omitted.

Also, in the present specification, it will be understood that when elements are “connected” or “coupled” to each other, the elements may be directly connected or coupled to each other, or may be indirectly connected or coupled to each other with an intervening element therebetween.

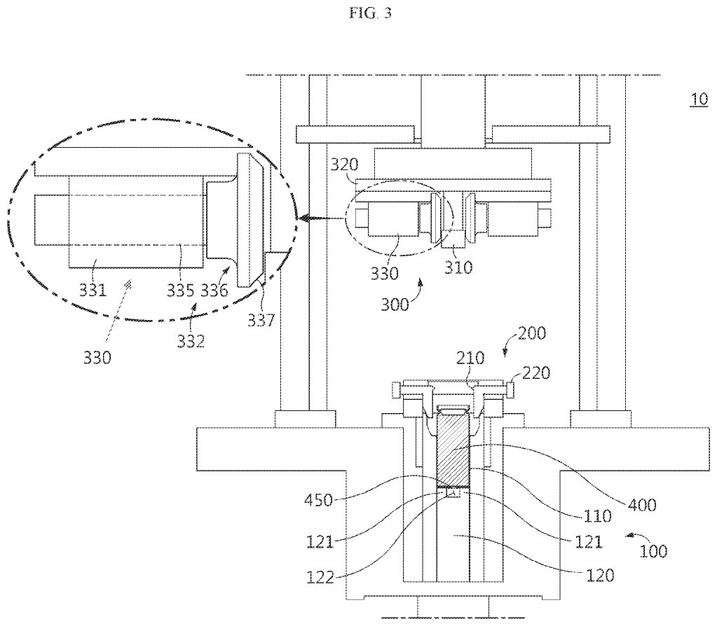

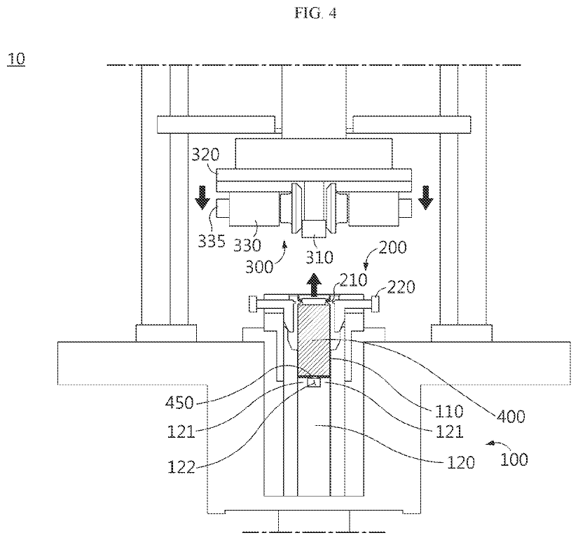

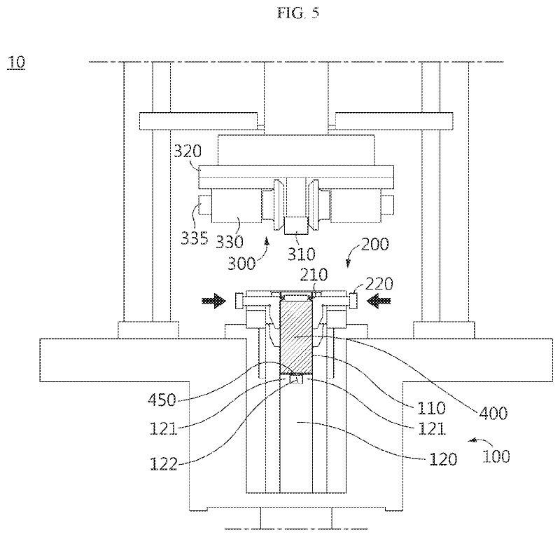

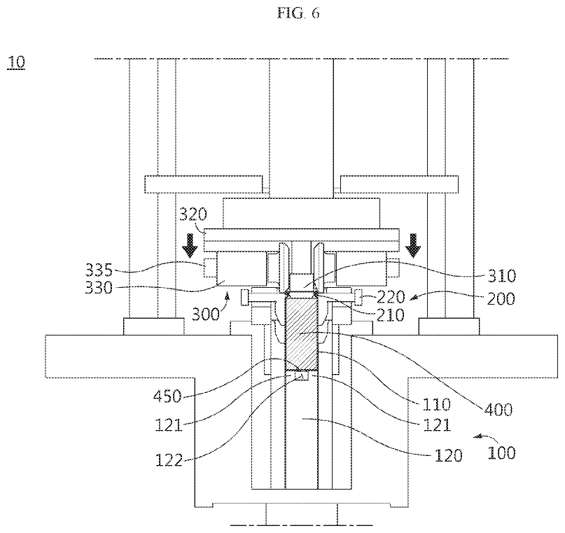

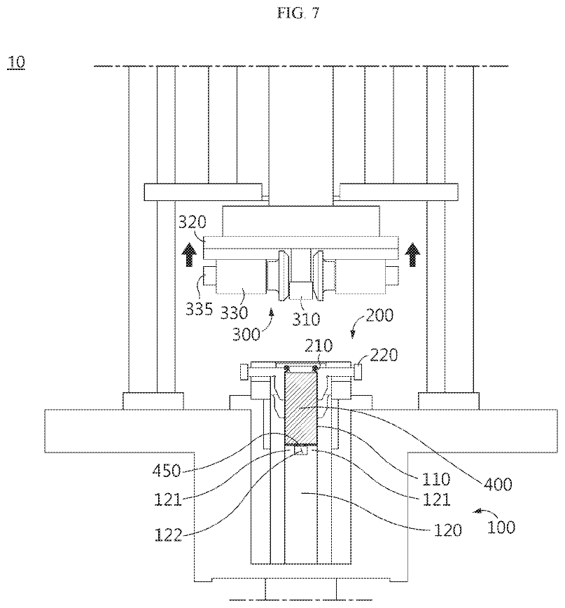

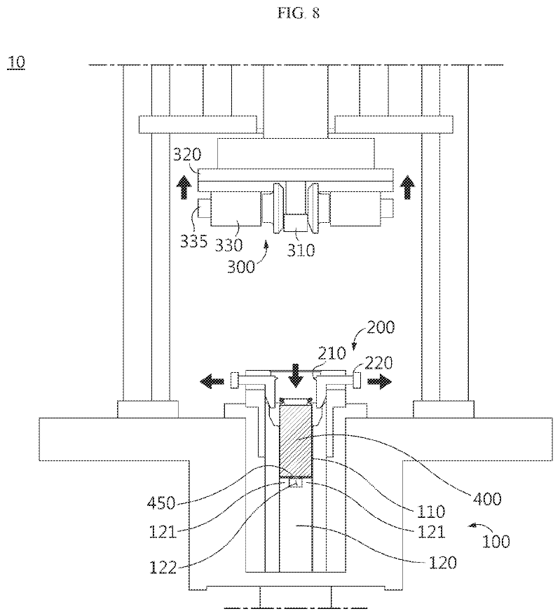

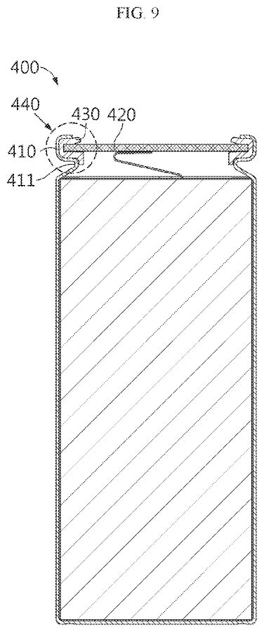

FIG. 1 is a view illustrating a cylindrical secondary battery cell of an embodiment before being formed by a cylindrical secondary battery cell production apparatus according to an embodiment of the present disclosure. FIG. 2 is a view illustrating a cylindrical secondary battery cell of another embodiment before being formed by a cylindrical secondary battery cell production apparatus according to an embodiment of the present disclosure. FIG. 3 is a view illustrating a state where a cylindrical secondary battery cell is inserted into a support member in a cylindrical secondary battery cell production apparatus according to an embodiment of the present disclosure. FIG. 4 is a view illustrating a state where the support member of FIG. 3 is lifted and a forming member is partially lowered. FIG. 5 is a view illustrating a state where a fixing member of FIG. 4 is used to fix a cylindrical secondary battery cell. FIG. 6 is a view illustrating a state where the forming member of FIG. 5 is completely lowered to rotate and press an end portion of a bottom can of a cylindrical secondary battery cell, to form a crimping portion. FIG. 7 is a view illustrating a state where forming of the crimping portion of the cylindrical secondary battery cell of FIG. 6 is completed and then the forming member is partially lifted. FIG. 8 is a view illustrating a state where the forming member of FIG. 7 is completely lifted, the fixing member is separated from the cylindrical secondary battery cell, and the support member is lowered. FIG. 9 is a view illustrating a state where the cylindrical secondary battery cell of FIG. 1 is formed by a cylindrical secondary battery cell production apparatus according to an embodiment of the present disclosure. FIG. 10 is a view illustrating a state where the cylindrical secondary battery cell of FIG. 2 is formed by a cylindrical secondary battery cell production apparatus according to an embodiment of the present disclosure.

Referring to FIGS. 1 and 9, a cylindrical secondary battery cell 400 includes a battery can 410 in which an electrode assembly and an electrolytic solution are accommodated, a cap plate 420 coupled to the battery can 410, and a gasket 430 located between the battery can 410 and the cap plate 420.

In a state where the gasket 430 is located between the battery can 410 and the cap plate 420 as shown in FIG. 1, an end portion of the battery can 410 and an end portion of the gasket 430 may be bent together for form a crimping portion 440 as shown in FIG. 9, and thus, the cylindrical secondary battery cell 400 may be sealed.

Referring to FIG. 1, an inner groove 411 is formed along a circumference of the battery can 410 of the cylindrical secondary battery cell 400 under the gasket 430.

The cylindrical secondary battery cell 400 of FIGS. 2 and 10 is a modified embodiment of the cylindrical secondary battery cell 400 of FIGS. 1 and 9. Referring to FIGS. 2 and 10, a positive electrode terminal 450 is formed opposite to the crimping portion 440.

Referring to FIGS. 2 and 10, the positive electrode terminal 450 may include a terminal inserting portion 451. The terminal inserting portion 451 may be inserted into the battery can 410 through a through-hole formed in a closed portion 412 of the battery can 410 and a lower end portion may be electrically connected to a central portion of a current collecting plate 470. The electrical connection may be made by welding. Examples of the welding may include laser welding, ultrasonic welding, and resistance welding.

The terminal inserting portion 451 may be coupled to the current collecting plate 470 by simultaneously passing through the battery can 410 and an insulator 480. While a lower edge portion of the terminal inserting portion 451 is pressed by a caulking jig, the positive electrode terminal 450 may be riveted toward an inner surface of an upper end portion of the battery can 410 to be firmly fixed to the through-hole.

That is, a lower peripheral end portion of the terminal inserting portion 451 may be bent toward an inner surface of the battery can 410 due to the application of the caulking jig. To this end, a maximum width of an end portion of the terminal inserting portion 451 may be greater than a maximum width of a hole of the battery can 410 formed through the penetration of the terminal inserting portion 451.

A riveting structure of the positive electrode terminal 450 may include the battery can 410 having a cylindrical shape with an open side, the positive electrode terminal 450 riveted through the through-hole formed in the bottom of the battery can 410, and a rivet gasket 460 located between the positive electrode terminal 450 and the through-hole.

The rivet gasket 460 may be formed of an insulating or elastic polymer resin. In an example, the rivet gasket 460 may be formed of, but is not limited to, polypropylene, polybutylene terephthalate, or polyfluorinated ethylene.

In another embodiment, the terminal inserting portion 451 may not be bent toward the inner surface of the battery can 410. For example, the terminal inserting portion 451 may have a substantially cylindrical shape passing through a hole formed at a substantially central portion of a top surface of the battery can 410.

The terminal inserting portion 451 may have, but is not limited to, a circular planar shape. The terminal inserting portion 451 may selectively have a polygonal shape, a star shape, or a shape having a leg extending from the center.

The terminal inserting portion 451 of the positive electrode terminal 450 may pass through a central hole of the insulator 480. A diameter of the central ole of the insulator 480 may be equal to or greater than a diameter of the terminal inserting portion 451. The terminal inserting portion 451 of the positive electrode terminal 450 may pass through the central hole of the insulator 480 and may be electrically coupled to the current collecting plate 470.

The insulator 480 is located between the battery can 410 and an electrode assembly, or between the battery can 410 and the current collecting plate 470 over the electrode assembly.

The crimping portion 440 and the inner groove 411 corresponding to a beading portion may be formed in the battery can 410. The inner groove 411 is formed by press-fitting inward an outer circumferential surface of the battery can 410.

The inner groove 411 may support the electrode assembly so that the electrode assembly having a size substantially corresponding to a width of the battery can 410 is not separated from the battery can 410, and may also function as a support on which the cap plate 420 is seated. Also, the inner groove 411 supports an outer circumferential surface of the gasket 430.

Referring to FIG. 10, the crimping portion 440 extends to the inside of the battery can 410 and is bent to surround and fix an edge of the cap plate 420 along with the gasket 430. The crimping portion 440 may be formed opposite to the positive electrode terminal 450 with respect to an arrangement state of the battery can 410.

A lower current collecting plate 490 is coupled to a lower portion of the electrode assembly. The lower current collecting plate 490 is formed of a conductive metal material such as aluminum, steel, copper, or nickel, and is electrically connected to the battery can 410. To this end, at least a part am edge portion of the lower current collecting plate 490 may be located and fixed between the inner surface of the battery can 410 and the gasket 430.

In an embodiment, at least a part of an edge portion of the lower current collecting plate 490 may be welded to a portion of the inner groove 411 while being supported on a lower surface of the portion of the inner groove 411 formed in the battery can 410. In a modified embodiment, at least a part of an edge portion of the lower current collecting plate 490 may be directly welded to an inner wall surface of the battery can 410.

In a cylindrical secondary battery cell production apparatus 10 according to an embodiment of the present disclosure, an end portion of the battery can 410 and an end portion of the gasket 430 are formed together to form the crimping portion 440, so that the cylindrical secondary battery cell 400 of FIG. 1 or the cylindrical secondary battery cell 400 of FIG. 2 is sealed.

Referring to the drawings, the cylindrical secondary battery cell production apparatus 10 according to an embodiment of the present disclosure includes a support member 100, a fixing member 200, and a forming member 300. Although the cylindrical secondary battery cell 400 of FIG. 2 is inserted and formed in FIGS. 3 through 8, the cylindrical secondary battery cell 400 of FIG. 1 may also be produced by the cylindrical secondary battery cell production apparatus 10 according to an embodiment of the present disclosure.

The cylindrical secondary battery cell 400 is inserted into the support member 100. The cylindrical secondary battery cell 400 is inserted into the support member 100 in a state where, as shown in FIG. 2, an end portion of the battery can 410 and an end portion of the gasket 430 may be arranged to face a preset direction, for example, to face upward, and the cap plate 420 contacts the gasket 430. The gasket 430 is located inside the battery can 410 and contacts the battery can 410, and the cap plate 420 is located inside the gasket 430 and contacts the gasket 430. The cylindrical secondary battery cell 400 before the crimping portion 440 is formed is inserted into the support member 100.

The support member 100 includes a receiving portion 110 and a first moving portion 120. An inner space is formed in the receiving portion 110, and the cylindrical secondary battery cell 400 is inserted into the inner space. The first moving portion 120 is provided to move the cylindrical secondary battery cell 400 toward the fixing member 200. Referring to FIGS. 3 and 4, for example, the first moving portion 120 may move the cylindrical secondary battery cell 400 upward. The first moving portion 120 may include any of various motors or a hydraulic pump.

A pair of protrusions 121 may be formed on both end portions of the first moving portion 120, and a preset space 122 may be formed between the pair of protrusions 121. The positive electrode terminal 450 of the cylindrical secondary battery cell 400 of FIG. 2 may be inserted into the space 122. As such, when the positive electrode terminal 450 is inserted into the space 122, interference between the positive electrode terminal 450 and the first moving portion 120 may be prevented, and because the positive electrode terminal 450 is not pressed by the first moving portion 120, damage to the positive electrode terminal 450 may be prevented.

The fixing member 200 fixes the cylindrical secondary battery cell 400 moved to a preset position, for example, is lifted as shown in FIGS. 4 and 5, by the support member 100.

The fixing member 200 is inserted into the inner groove 411 of the battery can 410 to fix the cylindrical secondary battery cell 400. One or more fixing members 200 may be provided, and for example, four fixing members 200 may be provided to press and fix four portions of the inner groove 411 of the battery can 410.

The fixing member 200 may include a fixing protrusion 210 and a second moving portion 220. The fixing protrusion 210 is formed to be inserted into the inner groove 411 of the battery can 410, and is inserted into the groove 411 of the battery can 410 to fix the cylindrical secondary battery cell 400. The second moving portion 220 is coupled to the fixing protrusion 210 to move the fixing protrusion 210. The second moving portion 220 may include any of various motors or a hydraulic pump.

Referring to FIG. 6, the forming member 300 is located over the cylindrical secondary battery cell 400 fixed by the fixing member 200, and the forming member 300 rotates and presses an end portion of the battery can 400 to form the crimping portion 440 as shown in FIG. 10 (the crimping portion 440 is formed in the same manner as in FIGS. 9 and 10). That is, when the forming member 300 rotates and presses an outer side of the battery can 410, an end portion of the battery can 410 and an end portion of the gasket 430 are bent together to form the crimping portion 440.

The forming member 300 includes a support holder 310, a rotating plate 320, and a forming roller 330.

The support holder 310 contacts the cap plate 420. Because the support holder 310 acts as a central shaft with respect to the rotating plate 320 and contacts the cap plate 420, the support holder 310 is configured not to rotate in consideration of friction with the cap plate 420.

The rotating plate 320 is rotatably coupled to the support holder 310, and rotates about the support holder 310. A bearing may be coupled between the rotating plate 320 and the support holder 310. There may be various methods of rotating the rotating plate 320 in a state where the support holder 310 is fixed. For example, gear teeth (not show) may be formed on an outer circumferential surface of the rotating plate 320 and a motor (not show) that may be engaged with the gear teeth (not show) may be provided, so that the rotating plate 320 is rotated by a rotational force of the motor (not shown).

However, this is merely an example, and there may be more various methods of rotating the rotating plate 320.

The forming roller 330 is coupled to the rotating plate 320 and rotates along with the rotating plate 320, and presses an end portion of the battery can 410 to form the crimping portion 440.

Referring to FIG. 6, a pair of forming rollers 330 are provided around the support holder 310, and are coupled to the rotating plate 320 at a position spaced apart from the center of the rotating plate 320.

Referring to FIG. 3, the forming roller 330 includes a connection rod 331 and a pressing rod 332.

The connection rod 331 is coupled to the rotating plate 320 at a position spaced apart from the center of the rotating plate 320. The connection rod 331 rotates along with the rotation of the rotating plate 320.

The pressing rod 332 is coupled to the connection rod 331, is located around the support holder 310, and presses an end portion of the battery can 410. That is, the pressing rod 332 rotates along with the rotation of the connection rod 331 to form the battery can 410 and the gasket 430, thereby forming the crimping portion 440.

The pressing rod 332 may include a rotating shaft 335 and a roller member 336. The rotating shaft 335 is coupled to the connection rod 331 and rotates. The roller member 336 is coupled to the rotating shaft 335 and rotates along with the rotation of the rotating shaft 335.

When the rotating plate 320 rotates about the support holder 310, the roller member 336 may rotate alone with the rotating plate 320. In this case, the roller member 336 rotates in a horizontal direction in FIG. 3.

The roller member 336 may rotate along with the rotation of the rotating shaft 335. In this case, the roller member 336 rotates in a vertical direction in FIG. 3.

That is, the roller member 336 may rotate in a horizontal direction in FIG. 3, or may rotate in a vertical direction in FIG. 3.

Referring to FIGS. 3 and 6 together, an inclined portion 337 may be formed on a portion of the roller member 336 contacting an end portion of the battery can 410. The inclined portion 337 of the roller member 336 contacts the end portion of the battery can 410 to press the battery can 410. As such, when the inclined portion 337 is formed on the roller member 336, the battery can 410 and the gasket 430 may be easily bent.

Because the forming member 300 needs rigidity for forming the battery can 410 and the gasket 430, the forming member 300 may be formed of any of various metal materials. However, a material of the forming member 300 is not limited to a metal material.

The following description of a cylindrical secondary battery cell production method according to an embodiment of the present disclosure may also be applied to the cylindrical secondary battery cell production apparatus 10 according to an embodiment of the present disclosure.

An operation and effect of the cylindrical secondary battery cell production method according to an embedment of the present disclosure will now be described with reference to the drawings. The same description as that made for the cylindrical secondary battery cell production apparatus 10 according to an embodiment of the present disclosure will be omitted.

Referring to FIG. 3, the cylindrical secondary battery cell 400 is inserted into the support member 100 in a state where, as shown in FIG. 2, an end portion of the battery can 410 and an end portion of the gasket 430 are arranged to face a preset direction, for example, to face upward, and the cap plate 420 contacts the gasket 430.

Referring to FIG. 4, the forming member 300 is lowered, and the support member 100 is lifted to a preset position, for example, a position of the fixing member 200. Referring to FIG. 5, the fixing member 200 moves from the outside toward the inside of the cylindrical secondary battery cell 400 and contacts the inner groove 411 of the battery can 410 to fix the cylindrical secondary battery cell 400.

Referring to FIG. 6, the forming member 300 is completely lowered and is located on the cylindrical secondary battery cell 400 fixed by the fixing member 200. The support holder 310 of the forming member 300 contacts the cap plate 420. The forming member 300 rotates and presses an end portion of the battery can 410, to form the crimping portion 440. That is, the forming roller 330 is coupled to the rotating plate 320 and rotates along with the rotating plate 320, to press an end portion of the battery can 410 and thus to form the crimping portion 440 as shown in FIG. 10.

Referring to FIG. 7, the forming of the crimping portion 440 is completed and the forming member 300 is lifted.

Referring to FIG. 8, the forming member 300 and the fixing member 200 return to their original positions, and the support member 100 is also lowered to its original position. In this state, the cylindrical secondary battery cell 400 is drawn out from the support member 100.

Although the embodiments of the present disclosure have been illustrated and described above, the present disclosure is not limited to the above-described specific embodiments. Various modified embodiments may be made by one of ordinary skill in the art without departing from the scope of the present disclosure as claimed in the claims.

### INDUSTRIAL APPLICABILITY

The present disclosure relates to a cylindrical secondary battery cell production apparatus and method, and particularly, may be used in industries related to secondary batteries.

1. An apparatus for producing a cylindrical secondary battery cell having a battery can in which an electrode assembly and an electrolytic solution are accommodated, a cap plate coupled to the battery can, and a gasket located between the battery can and the cap plate, the apparatus comprising:
a support member configured to receive the cylindrical secondary battery cell therein in a state where an end portion of the battery can and an end portion of the gasket are arranged to face a preset direction and the cap plate contacts the gasket;
at least one fixing member being movable relative to the support member to fix the cylindrical secondary battery cell after the cylindrical secondary battery cell is moved to a preset position by the support member; and
a forming member located over the support member, the forming member being movable towards the cylindrical secondary battery cell fixed by the fixing member to press the end portion of the battery can and being rotatable to form a crimping of the cylindrical secondary battery cell.

2. The apparatus for producing a cylindrical secondary battery cell according to claim 1, wherein the gasket is located inside the battery can and contacts the battery can, and the cap plate is located inside the gasket and contacts the gasket,
wherein the forming member is configured to press an outer side of the battery can.

3. The apparatus for producing a cylindrical secondary battery cell according to claim 1, wherein the support member comprises:
a receiving portion into which the cylindrical secondary battery cell is insertable; and
a first moving portion configured to move the cylindrical secondary battery cell toward the at least one fixing member.

4. The apparatus for producing a cylindrical secondary battery cell according to claim 1, wherein an inner groove is formed along a circumference of the battery can under the gasket, and
wherein the at least one fixing member is insertable into the inner groove to fix the cylindrical secondary battery cell.

5. The apparatus for producing a cylindrical secondary battery cell according to claim 4, wherein the at least one fixing member comprises:
a fixing protrusion formed insertable into the inner groove; and
a second moving portion coupled to the fixing protrusion to move the fixing protrusion.

6. The apparatus for producing a cylindrical secondary battery cell according to claim 1, wherein the forming member comprises:
a support holder configured to contact the cap plate;
a rotating plate rotatably coupled to the support holder to rotate about the support holder; and
at least one forming roller coupled to the rotating plate, the at least one forming roller being configured to rotate with the rotating plate, and the at least one forming roller being configured to press the end portion of the battery can to form the crimping portion.

7. The apparatus for producing a cylindrical secondary battery cell according to claim 6, wherein the at least one forming roller is a pair of forming rollers coupled to the rotating plate at positions, spaced apart from a center of the rotating plate to be rotatable around the support holder.

8. The apparatus for producing a cylindrical secondary battery cell according to claim 6, wherein the at least one forming roller comprises:
a connection rod coupled to the rotating plate; and
a pressing rod coupled to the connection rod, the pressing rod being spaced from the support holder, and the pressing rod being configured to press the end portion of the battery can.

9. The apparatus for producing a cylindrical secondary battery cell according to claim 8, wherein the pressing rod comprises:
a rotating shaft coupled to the connection rod; and
a roller member coupled to the rotating shaft.

10. The apparatus for producing a cylindrical secondary battery cell according to claim 9, wherein an inclined portion is formed on a portion of the roller member configured to contact the end portion of the battery can.

11. The apparatus for producing a cylindrical secondary battery cell according to claim 1, wherein the forming member is formed of a metal material.

12. A method of producing a cylindrical secondary battery cell having a battery can in which an electrode assembly and an electrolytic solution are accommodated, a cap plate coupled to an upper side of the battery can, and a gasket located between the battery can and the cap plate, the method comprising:
inserting the cylindrical secondary battery cell into a support member in a state where an end portion of the battery can and an end portion of the gasket are arranged to face a preset direction and the cap plate contacts the gasket;
moving the cylindrical secondary battery cell to a preset position by the support member;
fixing, by a fixing member, the cylindrical secondary battery cell moved to the preset position by the support member; and
forming a crimping portion by causing a forming member located over the support member to move towards the cylindrical secondary battery cell fixed by the fixing member and to rotate and press the end portion of the battery can with the forming member.

13. The method of producing a cylindrical secondary battery cell according to claim 12, wherein the forming member includes a rotating plate and a forming roller coupled to the rotating plate, and
wherein the forming the crimping portion comprises rotating the rotating plate along with the forming roller to press the end portion of the battery can.

14. The method of producing a cylindrical secondary battery cell according to claim 12, wherein the support member comprises:
a receiving portion into which the cylindrical secondary battery cell is inserted; and
a first moving portion configured to move the cylindrical secondary battery cell toward the at least one fixing member.

15. The method of producing a cylindrical secondary battery cell according to claim 12, wherein an inner groove is formed along a circumference of the battery can under the gasket, and
wherein the fixing the cylindrical secondary battery cell comprises inserting the fixing member into the inner groove to fix the cylindrical secondary battery cell.

16. The method of producing a cylindrical secondary battery cell according to claim 12, wherein the forming member comprises:
a support holder; and
the rotating plate rotatably coupled to the support holder to rotate about the support holder,
wherein forming the crimping portion comprises moving the support holder to directly contact the cap plate such that the support holder does not rotate relative to the cap plate.
